(19) United States
(12) Patent Application Publication
(10) Pub. No.: US 2019/0017477 A1
(43) Pub. Date: Jan. 17, 2019

(54) Multi-Fuel Combustion Methods, Devices and Engines Using the Same

(71) Applicant: QuantLogic Corporation, Sugary Land, TX (US)

(72) Inventor: Deyang Hou, Sugar Land, TX (US)

(73) Assignee: QuantLogic Corporation, Sugar Land, TX (US)

(21) Appl. No.: 16/069,270

(22) PCT Filed: Jan. 12, 2016
(86) PCT No.: PCT/US2016/013107

§ 371 Date: Jul. 11, 2018

(51) Int. Cl. F02M 45/08; F02M 43/04; F02B 23/06; F02B 23/10; F02D 19/06; F02D 41/00; F02D 41/40

(52) U.S. Cl. CPC F02M 45/086; F02M 43/04; F02B 23/0669; F02B 23/101; F02B 2023/103; F02D 19/0689; F02D 41/0025; F02D 41/401; F02D 41/402; F02D 19/0694

(57) ABSTRACT

This invention discloses a combustion method, which is for an internal combustion engine, which utilizes variable spray patterns matched with a combustion chamber composing of multiple connected spaces based on injection timings and engine loads. This invention provides means to control propagation paths of combustion reaction radicals and control pressure rise rate, and also provides means to promote stratification of premixed charges. An internal combustion engine utilizing the disclosed combustion methods is also disclosed.

### CROSS REFERENCE TO RELATED APPLICATION

This application is the National Stage Entry of PCT/US2016/013107.

### BACKGROUND OF THE INVENTION

### 1. Field of the Invention

The present invention relates to combustion methods, devices, and an internal combustion engine using the same, either compression ignition or spark ignition internal combustion engines.

### 2. Description of the Related Art

This application was based on U.S. Provisional Application 62/021,037, filed on Jul. 4, 2014.

While the engine industries have put great efforts for Homogenous Charge Compression Ignition (HCCI) and Premixed Charge Compression Ignition (PCCI) PCCI combustion, the conventional multi-hole fuel injector and commercial fuel properties limit the operation ranges of HCCI and PCCI. The major reasons are due to the fixed injection angle and dense jet nature of conventional sprays. In addition, a single commercial diesel or gasoline fuel lacks the property desired for full-time HCCI or PCCI operations. Currently HCCI or PCCI can only operate in low to medium loads in practical applications, conventional fixed-area nozzle designs have to be compromised for low and high loads. A large spray angle for high loads will bring severe wall (cylinder liner) wetting issues for early injections dictated by HCCI/PCCI mixture formation requirements. A fixed narrow spray angle optimized for premixing will generate more soot formation for high loads. Thus, a variable spray angle and penetration are much better positioned to solve this contradiction between requirements for different injection timings and operation loads. This invention has solved this wall-wetting issue through providing a variable spray angle, which is smaller for early injection and becomes larger for late injection, and a variable spray pattern, which is soft hollow conical mist-like spray, or smaller narrow angle multiple jets, for early injection with less penetration strength, and becomes larger multi-jet for late injection with higher penetration strength. Such a variable spray fuel injector was documented in PCT/US11/56002, PCT/US12/68584, and PCT/US15/23205.

Mixture formation is most critical for PCCI combustion. The essential feature of PCCI is ‘premixed charge’, thus the in-cylinder equivalence ratio distribution is the most critical factor deciding engine emissions and performance. Current practices indicated that only low to moderate loads are practical to deploy HCCI or PCCI due to difficulty in controlling combustion starting point and pressure rise rate. Thus, an effective method to control the combustion reaction rate is important to extend the HCCI or PCCI operation maps. This may include leveraging different fuel properties for different injection timings and leveraging novel combustion chamber spaces to control the reaction flow paths.

In addition, lean burn gasoline combustion can offer higher engine efficiency, but also has challenges of ignition and combustion stability. By leveraging the variable spray angle injection method here, we can offer both globally homogeneous lean mixture and locally richer mixture to ensure ignition and combustion stability.

### SUMMARY OF THE INVENTION

The innovative design of this invention has solved early injection wall-wetting issues through providing a variable spray angle, which is smaller for early injection and becomes larger for late injection, and a variable spray pattern, which is soft hollow conical mist-like spray or narrow angle multi-jets for early injection with less penetration strength, and becomes multi-jet for late injection with higher penetration strength.

The said combustion method here proposed uses a novel combustion chamber design, which divides the combustion reaction space into a plural number of smaller spaces, which has more constrains for reaction radical paths and pressure rise rate before top dead center (TDC). After TDC, the constrained reaction zone can join together, so faster combustion is enabled with a premixed charge to both improve combustion efficiency and reduce emissions.

A premixed charge of fuel and air is desirable for reducing emissions. However, for high engine loads, if all fuel and air is premixed before TDC, in the event of out of controlled combustion before TDC, the sudden release of all the heat energy could damage the engine. Thus, at high engine loads, only partially premix fuel and air before TDC is desirable. At the same time, in order to reduce emissions, an on-going ‘premixing’ process is desired. Thus, a novel method for introducing fuel into the combustion chamber space is desired to distribute certain amount of fuel in desirable locations and prepare the fuel as premixed charge to join faster combustion reaction only after TDC. This innovative method is realized by hiding lean mixture in outer chamber spaces and introducing fuels on-fly after TDC.

By introducing fuel both with early injection and late injection with adaptive means in the same power cycle, we can produce an adaptive mixed-mode combustion, or adaptive PCCI combustion. In the adaptive PCCI, early PCCI is used to generate in-cylinder radicals to accelerate diffusion combustion and reduce NO sub (x), while accelerated diffusion combustion is used to consume CO and HC produced by PCCI and stabilize combustion. Thus, adaptive PCCI gains significantly enhanced engine efficiency and clean in-cylinder combustion simultaneously.

### BRIEF DESCRIPTION OF THE DRAWINGS

FIG. 1 is an illustration of the nature of a conventional combustion chamber and spray;

FIG. 2(a) is a side view of said hollow conical spray (13) pattern; ‘a’ is half conical spray angle;

FIG. 2(b) is a side view of multi-jet spray (14) pattern;

FIG. 3 is a top view of a mixed-mode multi-jet and hollow conical spray pattern; 11—multi-jet spray, 12—hollow conical spray;

FIG. 4 is an illustration of the spray pattern variations along with injection timings; spray patterns can be varied from hollow conical spray to multi-jet spray; 41—hollow conical spray with small spray angle 2a; 42—hollow conical spray with larger spray angle 2b; 43—multi-jet spray with larger spray angle 2c;

FIG. 5 is an illustration of the spray pattern variations along with injection timings; spray patterns can be varied from narrow angle multi-jet sprays to wider angle multi-jet sprays; 41—multi-jet sprays with small spray angle 2a; 42—multi-jet sprays with larger spray angle 2b; 43—multi-jet spray with larger spray angle 2c;

FIG. 6 is an illustration of an exemplary matching of variable spray angle jets with combustion chamber, with narrower angle sprays matched with outer chamber space, and wider spray angle multi-jet sprays matched with inner chamber space. FIG. 6 is an illustration for compression ignition.

FIG. 6(a) is an exemplary internal combustion engine embodiment based on said combustion methods with early injection shown;

FIG. 6(b) is an exemplary internal combustion engine embodiment based on said combustion methods with late injection shown;

FIG. 6(c) is an exemplary internal combustion engine embodiment based on said combustion methods with post injection shown;

In FIG. 6, 61—piston, 611—central combustion chamber, 612—outer combustion chamber, 62—cylinder, 63—intake valve, 64—exhaust valve, 41—narrow spray angle jets for early injection, 43—wide spray angle jets for late injection, 44—narrow spray angle jets for post injection,

FIG. 7, 8 are illustrations of an exemplary combustion chamber with two annular spaces, which constrains the chemical radical propagation paths; C01—inner chamber space, C02—outer combustion chamber space; A—point in outer combustion chamber space B—point in inner combustion chamber space; FIG. 7 is a 2-D illustration, while FIG. 8 is a 3-D illustration.

FIG. 9 is an illustration of heat release for conventional diffusion combustion. Initial heat release (11) is associated with high NOx formation and is overlapped with main heat release (12) from diffusion combustion.

FIG. 10 is an illustration of heat releases for Adaptive Compression-Ignition Combustion. First heat release (21) is associated with clean early premixed combustion, thus reduces diffusion combustion of main injection (22). The twin triangular shape heat release reduces emissions and provides more flexibility for thermal efficiency optimization.

FIG. 11 Exemplary heat release curves of a combustion engine using the said Adaptive Compression-Ignition Combustion method. The initial heat release (sharper triangle) from earlier jets is separated from heat release from later multi-jets. Heat release from earlier jets and that from late jets are separate sequential events. The separate heat releases form a twin triangular shape heat release curve.

FIG. 12 is an illustration of an exemplary matching of variable spray angle jets with combustion chamber, with narrower angle sprays matched with outer chamber space, and wider spray angle multi-jet sprays matched with inner chamber space. FIG. 12 is an illustration for spark ignition engines.

FIG. 12(a) is an exemplary internal combustion engine embodiment based on said combustion methods with early injection shown, which is for generating lean homogenous charge;

FIG. 12(b) is an exemplary internal combustion engine embodiment based on said combustion methods with late injection shown, which is for stratification;

FIG. 12(c) is an exemplary internal combustion engine embodiment based on said combustion methods with post injection shown;

In FIG. 12, 61—piston, 611—central combustion chamber, 612—outer combustion chamber, 62—cylinder, 63—intake valve, 64—exhaust valve, 65—micro-channels embedded on piston top, 66—spark plug, 41—narrow spray angle jets for early injection, 43—wide spray angle jets for late injection, 44—narrow spray angle jets for post injection,

FIG. 13 is an illustration of one embodiment of one variable orifice injector capable of delivering dual fuels with variable spray patterns of hollow conical sprays and multi-jet sprays with different spray angles as disclosed in PCT/US11/56002.

FIG. 14 is an illustration of one embodiment of one variable orifice injector capable of delivering fuels with variable spray patterns of multi-jet sprays with different spray angles, as described in PCT/US15/23205.

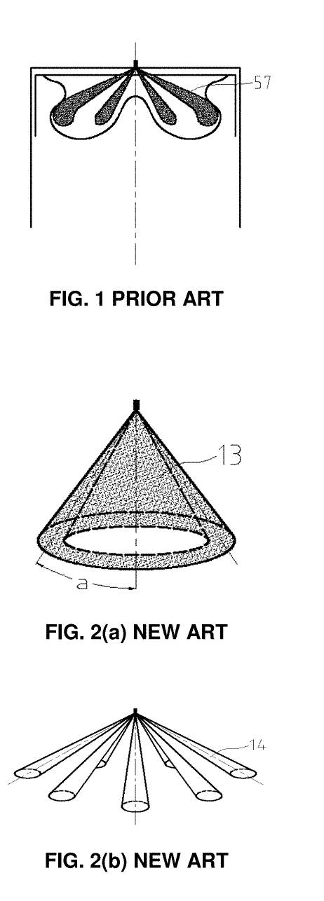

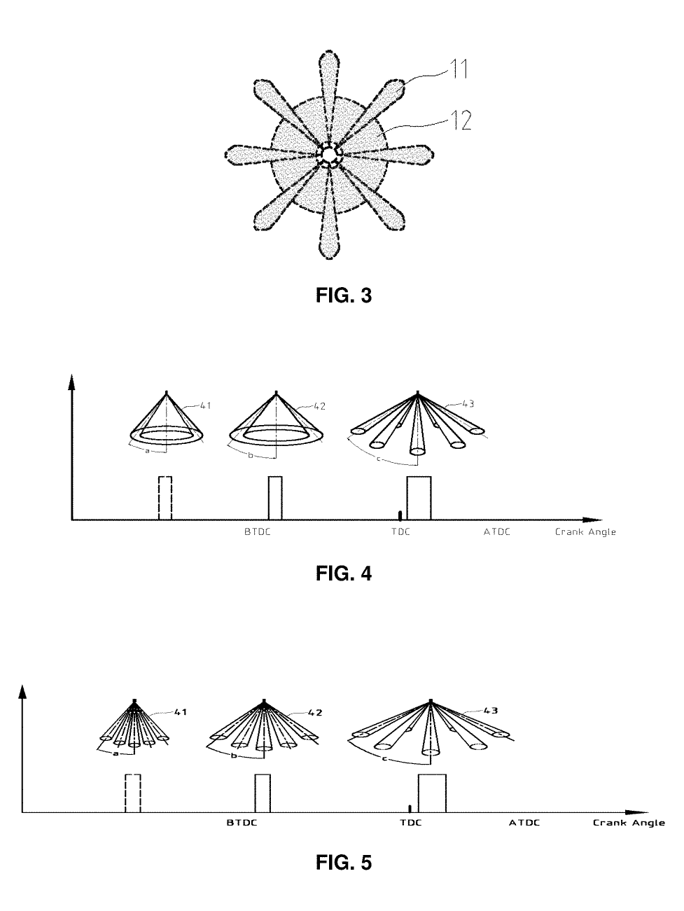

### DESCRIPTION OF THE PREFERRED EMBODIMENTS

A method of combustion, comprising steps of: (i) determining fuel injection timings by engine speed and engine loads, (ii) varying injection spray angles based upon injection timing, wherein injection spray angles increase with injection timings when the engine piston is closing to engine top dead center (TDC) and injection spray angles decrease with early and late injection timings when the engine piston is away from TDC, (iv) varying spray patterns wherein spray patterns tend toward hollow conical shapes with determined early and late injection timings, and tend toward a multi-jet shape with determined late injection timings,

As shown in FIG. 4, the spray pattern can vary along with injection timings; spray patterns can be varied from hollow conical spray with small angles, to multi-jet spray with larger angle, as shown in FIGS. 2 (a) &(b);

A method of combustion according to above paragraphs, further utilizing a combustion chamber composing plural number of annular inner spaces, which provide adaptive means to distribute mixture charges and to control propagation paths of combustion reaction radicals and control pressure rise rate, which also provide means to promote stratification of premixed charges;

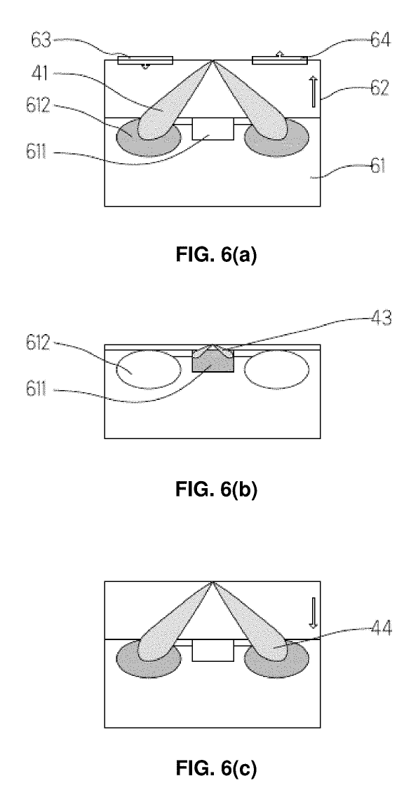

FIG. 6 is an illustration of an exemplary matching of variable spray angle jets with combustion chamber, with narrower angle sprays matched with outer chamber space, and wider angle multi-jet sprays matched with inner chamber space.

The hollow conical sprays and multi-jet sprays in FIG. 6 can be a single fuel such as diesel, bio-diesel, gasoline fuels, ethanol fuels, methanol fuels, LNG/CNG, LPG.

The hollow conical sprays and multi-jet sprays in FIG. 6 can be at least two different fuels from a group of fuels (diesel, bio-diesel, gasoline fuels, ethanol fuels, methanol fuels, LNG/CNG, LPG). In the multi-fuel case, the multi-jet spray generally carries a higher cetane number or lower octane number to ensure compression-ignition around TDC.

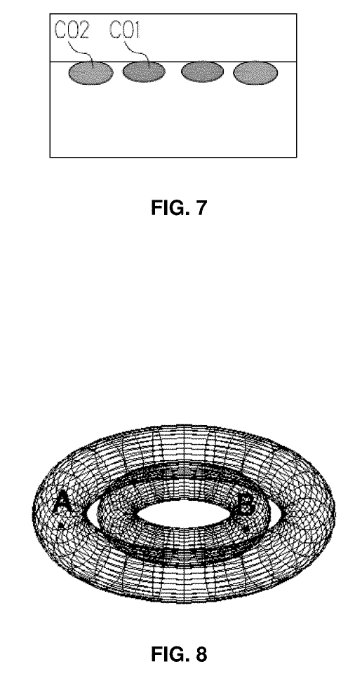

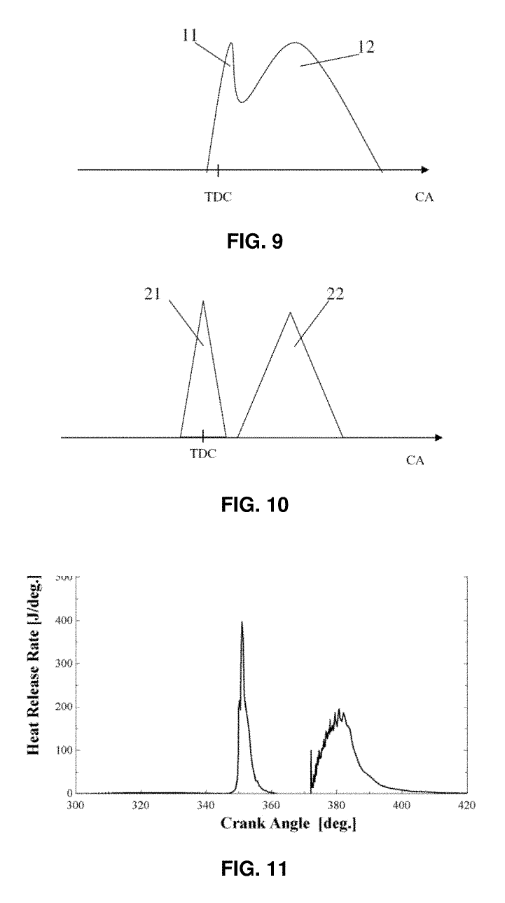

FIGS. 7&8 are illustrations of an exemplary combustion chamber with two annular spaces, which constrains the chemical radical propagation path. Point A & B in chamber space can not see each other directly, the reaction information in point A is restrained to propagate to point B. Thus, the reaction radical paths are well controlled, the pressure rise rate could be controlled for premixed charges.

A combustion method according to above paragraphs, comprising steps of defining a smaller variable spray angle, preferably between 50˜120 for early injections, and a larger variable spray angle, preferably between 120˜150 degree, for late injections closing to engine top dead center;

A combustion method according to above paragraphs, comprising steps of defining a single injection and a plural number of earlier injections with injection timings approximately between 120˜30 degree before top dead center with hollow conical spray shapes, and a main injection with starting injection timing preferably between −10˜20 degree around top dead center with multi-jet sprays, and an optional post injection with injection timings approximately between 30˜70 degree after top dead center with hollow conical spray shapes;

A combustion method, wherein it has single injection or a plural number of earlier injections with injection conducted approximately between 120˜30 degree before TDC (BTDC) with multi-jets having smaller angles, and at least one main fuel injection conducted approximately between −10˜30 degree after TDC (ATDC), preferably starting at 0˜15 degree ATDC, with multi-jet sprays having larger spray angles. Refer to FIG. 5.

A combustion method according to above paragraphs, further comprising steps of utilizing a plural number of pressure levels for fuel injection, with lower pressure level less than 1000 bar, preferably in the range of 300˜500 bar, for early injections within range of 120˜30 degree before top dead center; and high injection pressure level above 500 bar, preferably in the range of 1000 bar˜2500 bar, with higher pressure preferred, for late injections starting preferably −10˜20 degree after top dead center, depending on the engine speed and fuel injection quantity;

An internal combustion engine composing at least: a said fuel injector with variable injection orifice as in above paragraphs, a combustion chamber, a piston, a cylinder, and a cylinder head with intake and exhaust valves, with said internal combustion engine using the combustion method or devices as in above paragraphs individually or collectively to have means to distribute fuel in combustion chamber spaces, to control pressure rise, to control quantity of fuel for premixed mixture formation for adaptive premix combustion for different engine speeds and loads;

An internal combustion engine according to above paragraph, further has a compression ratio approximately in the range of 12˜18, preferably 14˜16, a low swirl ratio approximately in the rage of 0˜1.5, preferably 0.2˜1.0;

FIG. 6 is an exemplary internal combustion engine embodiment based on said combustion methods with late injection shown using a multi-jet spray pattern, the spray angle is preferably in the range of 130˜150 degree. The late charge of the fuel will leverage the radicals produced by early PCCI, and accelerate the diffusion combustion, thus produce high efficiency accelerated diffusion combustion (ADC).

The processes in FIG. 6 can be in the same engine power cycle to produce an adaptive mixed-mode premixed and conventional combustion. The new mixed-mode adaptive PCCI combustion can successfully merge the merits of early PCCI and diffusion combustion. The adaptive PCCI minimizes the drawbacks of each combustion mode, produces ultra low emissions and high efficiency with stable combustion simultaneously.

Statement A: A method of combustion, comprising steps of: (i) determining fuel injection timings and quantities according to engine speeds and engine loads, (ii) direct injecting fuels into combustion chamber by varying injection spray angles based upon injection timings, wherein wider injection spray angles are used for injection timings when the engine piston is closing to engine top dead center (TDC), and narrower injection spray angles are used for early and post injection timings when the engine piston is away from TDC, (iii) matching the narrower spray angle jets with outer combustion chamber space for early and post injection timings, and matching wider spray angle jets with inner combustion chamber spaces for injections around TDC.

A method of combustion of Statement A, wherein spray patterns tend toward hollow conical sprays with pre-determined early and post injection timings, and spray patterns tend toward multi-jet sprays with pre-determined late injection timings around TDC.

A method of combustion of Statement A, wherein spray patterns tend toward narrow spray angle multi-jets with pre-determined early and post injection timings, and spray patterns tend toward wider spray angle multi-jets with pre-determined injection timings around TDC.

A method of combustion of Statement A, wherein the fuel for different injection timings is from the same fuel from a group of diesel fuels, bio-diesel fuels, gasoline fuels, ethanol fuels, same fuel blends, natural gas, liquid petroleum gas, and methanol.

A method of combustion of Statement A, wherein the fuel for different injection timings is the same fuel from a group of gasoline fuels, ethanol fuels, fuel blends of gasoline and ethanol fuels, natural gas, liquid petroleum gas, and methanol, wherein fuel doses for late injections around TDC being added with ignition enhancers.

A method of combustion of Statement A, wherein the fuels for different injection timings are at least two different fuels from a group of diesel fuels, bio-diesel fuels, gasoline fuels, ethanol fuels, fuel blends of gasoline and diesel fuels, natural gas, liquid petroleum gas, and methanol, with earlier and post injections using higher octane number fuels, and late injections around TDC using low octane number fuels.

A method of combustion according to Statement A, which is for internal combustion engines, utilizing a combustion chamber composing plural number of annular inner spaces, which provide separated annular spaces to distribute fuel-air mixture charges and to control propagation paths of combustion reaction radicals, which also provide means to promote stratification of premixed charges.

A combustion method according to Statement A, comprising steps of defining a narrow variable spray angle, preferably between 50˜120 for early injections and post injections, and a wider variable spray angle, preferably between 120˜150 degree, for late injections closing to TDC.

A combustion method according to Statement A, comprising steps of defining at least a single earlier injections with injection timings approximately between 120˜30 degree before TDC with hollow conical spray shapes, and a main injection with starting injection timing preferably between −10˜20 degree around TDC with wider angle multi-jet sprays, and an optional post injection with injection timings approximately between 20˜60 degree after top dead center with narrow angle sprays.

An combustion method according to Statement A, further comprising steps of utilizing a plural number of pressure levels for fuel injections, with lower pressure level less than 1000 bar, preferably in the range of 300˜500 bar, for early injections and post injections within range of 120˜30 degree away from TDC; and high injection pressure level above 1000 bar, preferably in the range of 1000 bar˜2500 bar, for late injections 10˜20 degree around TDC, depending on the engine speeds and engine loads, wherein the different fuel pressure levels are provided by at least one of the following means including different cam profiles, different pressure common rail reservoirs, or local pressure amplification inside injectors.

A combustion method of Statement A, wherein the narrower spray angle jets and wider spray angle jets are introduced by a single fuel injector wherein it has a variable orifice and has means to provide different spray angles;

A combustion method of Statement A, wherein the smaller fuel jets and larger fuel jets are introduced by at least two separate fuel injectors wherein have means to provide different spray angles and spray patterns;

A combustion method of Statement A, wherein it has at least one single early injection conducted approximately between 360˜180 degree before TDC of intake stroke with multi-jets having narrower angles, and at least one main fuel injection conducted approximately between −20˜20 degree after TDC, with multi-jet sprays having wider spray angles;

A combustion method of Statement A, wherein the smaller fuel jets and larger fuel jets are introduced by a single fuel injector, wherein it has a variable orifice and has means to provide different spray angles and patterns.

Statement B: An internal combustion engine composing at least: at least one fuel injector capable of producing variable spray angles, a combustion chamber, a piston, a cylinder, and a cylinder head with intake and exhaust valves, with said internal combustion engine using the combustion method or devices to have means to distribute fuel in combustion chamber spaces, to control quantity of fuel for premixed mixture formation for different engine speeds and loads.

An internal combustion engine according to Statement B, further has a compression ratio approximately in the range of 14˜18, a swirl ratio approximately in the range of 0˜2.

An internal combustion engine of Statement B, where it has two fuel injectors per engine cylinder wherein one fuel injector has means to produce the said hollow conical smaller jets with smaller spray angles and one fuel injector has means to produce said multi-jets with wider spray angles, respectively.

An internal combustion engine of Statement B, where it has two fuel injectors per engine cylinder wherein one fuel injector has means to produce the said multi-jets with narrower spray angles and one fuel injector has means to produce said multi-jets with wider spray angles, respectively;

An internal combustion engine of Statement B, wherein it has a compression ratio approximately in the range of 14˜18, and a low swirl ratio approximately in the range of 0˜2;

An internal combustion engine of Statement B, has following integrated features:
a. for said engine at low engine loads, with approximately 50% of total fuel dose being injected as earlier fuel injection(s) approximately between 90˜45 degree crank angle (CA) before TDC of compression stroke, with approximately 30% of total fuel dose being injected as earlier fuel injection(s) approximately between 45-30 degree crank angle (CA) before TDC of compression stroke, and the rest of the fuel being injected approximately between 30-10 degree before TDC;
b. for said engine at medium engine loads, with approximately 50% of total fuel dose being injected as earlier fuel injection(s) approximately between 360-270 degree crank angle (CA) before TDC of intake stroke, with approximately 30% of total fuel dose injected as earlier fuel injection(s) approximately between 90-45 degree CA before TDC of compression stroke, and the rest of the fuel injected approximately between 20-0 degree before TDC.
c. for said engine at high engine loads, with approximately 30% of total fuel dose being injected as earlier fuel injection(s) approximately between 360-270 degree crank angle (CA) before TDC of intake stroke, with approximately 20˜30% of total fuel dose being injected as earlier fuel injection(s) approximately between 90-45 degree crank angle (CA) before TDC of compression stroke, with approximately 10% of total fuel injected approximately between 20-0 degree before TDC, with approximately 30˜40% of total fuel injected approximately between 10-30 degree after TDC.

An internal combustion engine of Statement B, has following integrated features: having a variable orifice fuel injector with approximately 6 to 10 spray holes having wider spray angles, and having means to produce hollow conical jets with narrower spray angles;

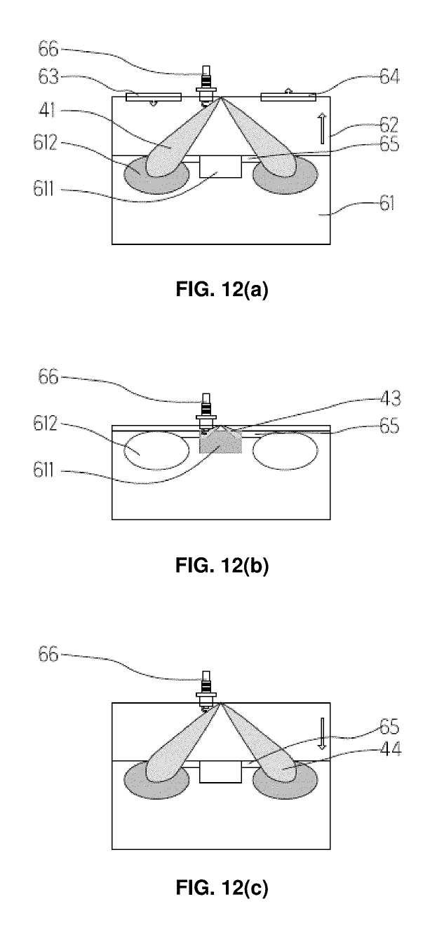

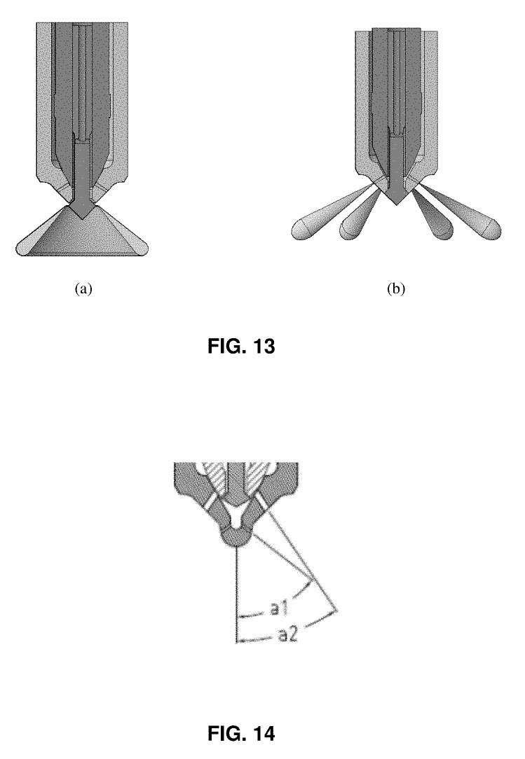

An internal combustion engine of Statement B, has following integrated features:
having a variable orifice fuel injector with approximately 6 to 10 larger spray holes having wider spray angles between 120˜150 degree, and having approximately 3 to 6 spray holes having narrower spray angles between 50˜120 degree.
   An internal combustion engine of Statement B, has following integrated features:
having a variable orifice fuel injector with approximately 3 to 6 larger spray holes having wider spray angles between 120˜150 degree, and having approximately 6 to 12 spray holes having narrower spray angles between 50˜120 degree.
   An internal combustion engine of Statement B, has following integrated features:
a. said engine has a lower swirl ratio preferably between 0˜1.5, a preferred compression ratio of 14 to 18;
b. said engine has an exhaust gas recirculation (EGR) ratio approximately between 0˜50%, depending on engine loads, with lower loads tend to have higher EGR ratios.
   Statement C: A method of combustion, As illustrated in FIG. 12, comprising steps of: (i) determining fuel injection timings and quantities according to engine speeds and engine loads, (ii) direct injecting fuels into combustion chamber by varying injection spray angles based on injection timings, wherein narrower injection spray angles are used for early and post injection timings when the engine piston is away from TDC, and wider injection spray angles are used for injection timings when the engine piston is closing to engine top dead center (TDC), and (iii) using the narrower spray angle jets for generating early homogeneous charge, and wider spray angle for generating locally stratified late charges to couple with spark plug to ensure ignition stability.

A combustion method of Statement C, wherein the wider spray angle jets for stratification have much lower injection flow rate than narrower spray angle jets.

A combustion method of Statement C, wherein the narrower spray angle jets are matched with outer combustion chamber space, the wider spray angle jets are matched with inner combustion chamber space.

A combustion method of Statement C, wherein the spark plug is falling within the inner combustion chamber space, after ignition, the combustion reacting flow is rushed out toward outer chamber space though small channels embedded in piston top to ignite the charges in outer combustion chamber space.

An internal combustion engine, as illustrated in FIG. 12, composing: at least one fuel injector capable of producing variable spray angles, a combustion chamber having at least two divided chamber spaces on piston top, a piston, a cylinder, and a cylinder head with intake and exhaust valves, a spark plug, the said engine is operated such that it forms lean homogeneous mixture with the said variable orifice injector by activating its narrower spray angle jets for early injections, and it forms minor mixture stratification by activating its wider spray angle small jets for late injections, while the said small jets are coupled with said spark plug to form optimized mixture to ensure ignition stability.

What is claimed is:

1. A method of combustion, comprising steps of: (i) determining fuel injection timings and quantities according to engine speeds and engine loads, (ii) direct injecting fuels into combustion chamber by varying injection spray angles based on injection timings, wherein wider injection spray angles are used for injection timings when the engine piston is closing to engine top dead center (TDC), and narrower injection spray angles are used for early and post injection timings when the engine piston is away from TDC, (iii) matching the narrower spray angle jets with outer combustion chamber space for early and late injection timings, and matching wider spray angle jets with inner combustion chamber spaces for injections around TDC.

2. A method of combustion of claim 1, wherein spray patterns tend toward hollow conical sprays with pre-determined early and post injection timings, and spray patterns tend toward multi-jet sprays with pre-determined late injection timings around TDC.

3. A method of combustion of claim 1, wherein spray patterns tend toward narrow spray angle multi-jets with pre-determined early and post injection timings, and spray patterns tend toward wider spray angle multi-jets with pre-determined injection timings around TDC.

4. A method of combustion of claim 1, wherein the fuel for different injection timings is from the same fuel from a group of diesel fuels, bio-diesel fuels, gasoline fuels, ethanol fuels, same fuel blends, natural gas, liquid petroleum gas, and methanol.

5. A method of combustion of claim 1, wherein the fuel for different injection timings is the same fuel from a group of gasoline fuels, ethanol fuels, fuel blends of gasoline and ethanol fuels, natural gas, liquid petroleum gas, and methanol, wherein fuel doses for late injections around TDC being added with ignition enhancers to reduce octane number.

6. A method of combustion of claim 1, wherein the fuels for different injection timings are at least two different fuels with different octane numbers or cetane numbers from at least one group of diesel fuels, bio-diesel fuels, gasoline fuels, ethanol fuels, fuel blends of gasoline and diesel fuels, natural gas, liquid petroleum gas, and methanol, with earlier and post injections using higher octane number fuels, and late injections around TDC using low octane number fuels.

7. A method of combustion according to claim 1, which is for internal combustion engines, utilizing a combustion chamber composing plural number of annular chamber spaces, which provide separated annular spaces to distribute fuel-air mixture charges and to control propagation paths of combustion reaction radicals, which also provide means to promote stratification of premixed charges.

8. A combustion method according to claim 1, comprising steps of defining a narrow variable spray angle, preferably between 50˜120 for early injections and post injections, and a wider variable spray angle, preferably between 120˜150 degree, for late injections closing to TDC.

9. A combustion method according to claim 1, comprising steps of defining at least a single earlier injection with injection timings approximately between 120˜30 degree before TDC with hollow conical spray shapes, and a main injection with starting injection timing preferably between −20˜20 degree around TDC with wider angle multi-jet sprays, and an optional post injection with injection timing approximately between 20˜60 degree after top dead center with narrow angle hollow conical sprays.

10. An combustion method according to claim 1, further comprising steps of utilizing a plural number of pressure levels for fuel injections, with lower pressure level less than 1000 bar, preferably in the range of 200˜500 bar, for early injections and post injections within range of approximately 120˜30 degree away from TDC; and high injection pressure level above 500 bar, preferably in the range of 1000 bar˜2500 bar, for late injections approximately 10˜20 degree around TDC, depending on the engine speeds and engine loads, wherein the different fuel pressure levels are provided by at least one of the following means including different cam profiles, different pressure common rail reservoirs, or local pressure amplification inside injectors.

11. A combustion method of claim 1, wherein the narrower spray angle jets and wider spray angle jets are introduced by a single fuel injector wherein it has a variable orifice and has means to provide different spray angles;

12. A combustion method of claim 1, wherein the smaller fuel jets and larger fuel jets are introduced by at least two separate fuel injectors wherein have means to provide different spray angles and spray patterns;

13. A combustion method of claim 1, wherein it has at least one single early injection conducted approximately between 360˜180 degree before TDC with multi-jets having narrower angles, and at least one main fuel injection conducted approximately between 20 degree before and after TDC, with multi-jet sprays having wider spray angles;

14. A combustion method of claim 1, wherein the smaller fuel jets and larger fuel jets are introduced by a single fuel injector wherein it has a variable orifice and has means to switch between different spray angles and patterns.

15. An internal combustion engine composing: at least one fuel injector capable of producing jets with variable spray angles, a combustion chamber, a piston, a cylinder, and a cylinder head with intake and exhaust valves, wherein it has means to inject fuels with different spray angles at different injection timings to distribute fuel in combustion chamber spaces, to control quantity of fuel for premixed mixture formation and fuel stratification formation for different engine speeds and loads.

16. An internal combustion engine according to claim 15, further has a compression ratio approximately in the range of 14˜18, a swirl ratio approximately in the rage of 0˜2.

17. An internal combustion engine of claim 15, where it has two fuel injectors per engine cylinder wherein one fuel injector has means to produce the said hollow conical smaller jets with smaller spray angles and one fuel injector has means to produce said multi-jets with wider spray angles, respectively.

18. An internal combustion engine of claim 15, has following integrated features:
a. for said engine at low engine loads, with approximately 50% of total fuel dose being injected as earlier fuel injection(s) approximately between 90˜45 degree crank angle (CA) before TDC of compression stroke, with approximately 30% of total fuel dose being injected as earlier fuel injection(s) approximately between 45-30 degree crank angle (CA) before TDC of compression stroke, and the rest of the fuel being injected approximately between 30-10 degree before TDC;
b. for said engine at medium engine loads, with approximately 40-50% of total fuel dose being injected as earlier fuel injection(s) approximately between 360-270 degree crank angle (CA) before TDC, with approximately 30% of total fuel dose injected as earlier fuel injection(s) approximately between 90-45 degree CA before TDC of compression stroke, and the rest of the fuel injected approximately between −20-20 degree around TDC.
c. for said engine at high engine loads, with approximately 30% of total fuel dose being injected as earlier fuel injection(s) approximately between 360-270 degree crank angle (CA) before TDC, with approximately 20˜30% of total fuel dose being injected as earlier fuel injection(s) approximately between 90-45 degree crank angle (CA) before TDC of compression stroke, with approximately 10% of total fuel injected approximately between 20-0 degree around TDC, with approximately 30˜40% of total fuel injected approximately between 10-30 degree after TDC.

19. An internal combustion engine of claim 15, has following integrated features:
having a variable orifice fuel injector with approximately 6 to 10 spray holes having wider spray angles, and having means to produce hollow conical jets with narrower spray angles;

20. An internal combustion engine of claim 15, which is mainly a compression ignition engine, has following integrated features:
having a variable orifice fuel injector with approximately 6 to 10 larger spray holes having wider spray angles between 120˜150 degree, and having approximately 3 to 6 spray holes having narrower spray angles between 50˜120 degree.

21. An internal combustion engine of claim 15, which is mainly a spark ignition engine, has following integrated features:
having a variable orifice fuel injector with approximately 3 to 6 small spray holes having wider spray angles between 120˜150 degree, and having approximately 6 to 12 spray holes having narrower spray angles between 50˜120 degree.

22. An internal combustion engine of claim 15, has following integrated features:
a. said engine has a lower swirl ratio preferably between 0˜1.5, a preferred compression ratio of 14 to 18;
b. said engine has an exhaust gas recirculation (EGR) ratio approximately between 0˜50%, depending on engine loads, with lower loads tend to have higher EGR ratios.

23. An internal combustion engine of claim 15, has an spark plug for spark ignition of fuel charges.

24. An internal combustion engine of claim 15, has at least one fuel injection with diesel like fuels having cetane number suitable for compression ignition.

25. A method of combustion, comprising steps of: (i) determining fuel injection timings and quantities according to engine speeds and engine loads, (ii) direct injecting fuels into combustion chamber by varying injection spray angles based on injection timings, wherein narrower injection spray angles are used for early and post injections when the engine piston is away from TDC, and wider injection spray angles are used for injections when the engine piston is closing to engine top dead center (TDC), and (iii) using the narrower spray angle jets for generating early homogeneous charge, and wider spray angle jets for generating locally stratified late charges to couple with spark plug to ensure ignition stability.

26. A combustion method of claim 25, wherein the wider spray angle jets for stratification have much lower injection flow rate than narrower spray angle jets.

27. A combustion method of claim 25, wherein the narrower spray angle jets are matched with outer combustion chamber space, the wider spray angle jets are matched with inner combustion chamber space.

28. A combustion method of claim 25, wherein the spark plug is falling within the inner combustion chamber space, after ignition, the combustion reacting flows are rushed out toward outer chamber space though small channels embedded in piston top to ignite the mixture charges in outer combustion chamber space.

29. An internal combustion engine composing: at least one fuel injector capable of producing variable spray angles, a combustion chamber having at least two divided chamber spaces on piston top, a piston, a cylinder, and a cylinder head with intake and exhaust valves, a spark plug, the said engine is operated such that it forms lean homogeneous mixture with the said variable orifice injector by activating its narrower spray angle jets for early injections, and it forms minor mixture stratification by activating its wider spray angle small jets for late injections, while the said small jets are coupled with said spark plug to form optimized mixture to ensure ignition stability.
